(19) United States
(12) Patent Application Publication
(10) Pub. No.: US 2015/0291127 A1
(43) Pub. Date: Oct. 15, 2015

(54) WIRELESS DEVICE WITH ACCELEROMETER FOR OPTIMIZING POLLING

(71) Applicant: Lear Corporation, Southfield, MI (US)

(72) Inventor: Riad GHABRA, Northville, MI (US)

(21) Appl. No.: 14/634,169

(22) Filed: Feb. 27, 2015

Related U.S. Application Data
(60) Provisional application No. 61/979,722, filed on Apr. 15, 2014.

(51) Int. Cl. B60R 25/24; G01P 15/00

(52) U.S. Cl. CPC B60R 25/24; G01P 15/00

(57) ABSTRACT

A portable wireless device includes an accelerometer to determine movement of the device to trigger a polling operation. The polling operation is to wirelessly connect the portable wireless device to a vehicle to trigger a vehicle operation. The vehicle operation can be based on the position of the portable wireless device and/or movement of the portable wireless device. The vehicle includes an apparatus for determining a location of a portable wireless device in relation to a vehicle. The vehicle operation can further be based on the wireless device location.

The present application claims the benefit under 35 U.S.C. §119(e) to U.S. Patent Application No. 61/979,722, filed on 15 Apr. 2014, which is hereby incorporated by reference.

### TECHNICAL FIELD

Embodiments of the present disclosure generally provide for an apparatus and method for initiating polling between a wireless device and a vehicle.

### BACKGROUND

It is known to detect the location of a wireless device in relation to a vehicle. One implementation for detecting the location of the wireless device in relation to the vehicle is set forth directly below.

U.S. Patent Publication No. 2010/0076622 to Dickerhoof et al. provides a system for determining the location of a wireless device with respect to a vehicle. The system comprises a plurality of antennas positioned about the vehicle for receiving a wireless signal from the wireless device. The wireless signal corresponds to at least one of a command and status related to a predetermined vehicle operation. The system further comprises a controller operably coupled to each antenna. The controller is configured to generate a location signal indicative of the location of the wireless device based on the arrival time of the wireless signal at one or more antennas of the plurality of antennas and to control the operation of the predetermined vehicle operation based on the location signal.

### SUMMARY

In at least one embodiment, a portable wireless device includes an accelerometer to determine movement of the device to trigger a polling operation. The polling operation is to wirelessly connect the portable wireless device to a vehicle to trigger a vehicle operation. The vehicle operation can be based on the position of the portable wireless device and/or movement of the portable wireless device. In an embodiment, the vehicle includes an apparatus for determining a location of a portable wireless device in relation to a vehicle.

In at least one embodiment, an apparatus for determining a location of a portable wireless device in relation to a vehicle is provided. The apparatus includes a first base station that includes a first transceiver for being positioned about a vehicle. The first transceiver is configured to operate at a first operating frequency for transmitting and receiving at least one first signal to and from the portable wireless device to provide a first distance of the portable wireless device with respect to the vehicle. The first operating frequency generally corresponds to a distance accuracy value and the first distance generally corresponds to an actual distance of the portable wireless device from the vehicle that is adjusted by the distance accuracy value.

### BRIEF DESCRIPTION OF THE DRAWINGS

The embodiments of the present disclosure are pointed out with particularity. However, other features of the various embodiments will become more apparent and will be best understood by referring to the following detailed description in conjunction with the accompany drawings in which:

FIG. 1 depicts an apparatus for detecting a location of a wireless device in accordance with an embodiment;

FIG. 2 depicts a detailed schematic view of the wireless device, the main base station and the auxiliary base station in accordance with an embodiment;

FIG. 3 depicts a method for detecting the location of the wireless device in accordance with an embodiment;

FIG. 4 depicts a first distance, a second distance, and a third distance of the wireless device from the vehicle in accordance with an embodiment;

FIG. 5 depicts the manner in which the wireless device polls for a signal from the vehicle in accordance with an embodiment;

FIG. 6 depicts the manner in which the main base station monitors for the wireless device in accordance with an embodiment;

FIG. 7 depicts the manner in which the wireless device is actuated by a user and timing of the receiver in the vehicle in accordance with an embodiment;

FIG. 8 depicts the wireless device polling internally to check for movement in accordance with an embodiment; and

FIG. 9 depicts a simplified schematic view of the wireless device in accordance with an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The embodiments of the present disclosure generally provide for circuitry that may include a plurality of circuits, discrete components, integrated circuits or other electrical devices. All references to the circuitry, circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, RAM, ROM, EPROM, EEPROM, or other suitable variants thereof) and stored instructions, e.g., software, which co-act with one another to perform any number of the operation(s) as disclosed herein.

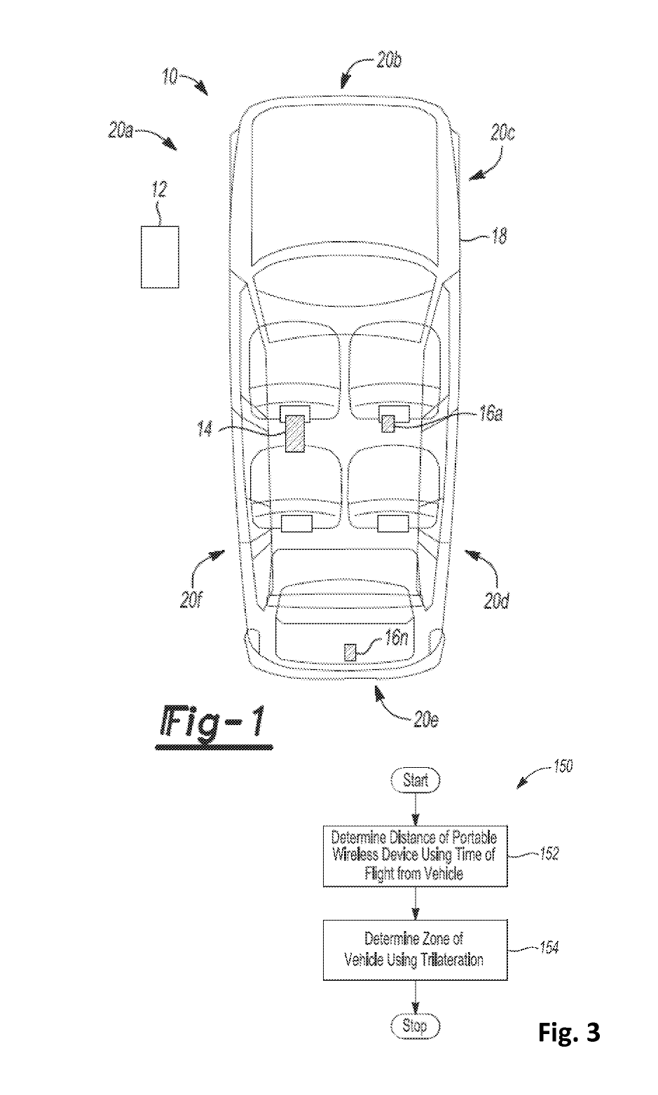

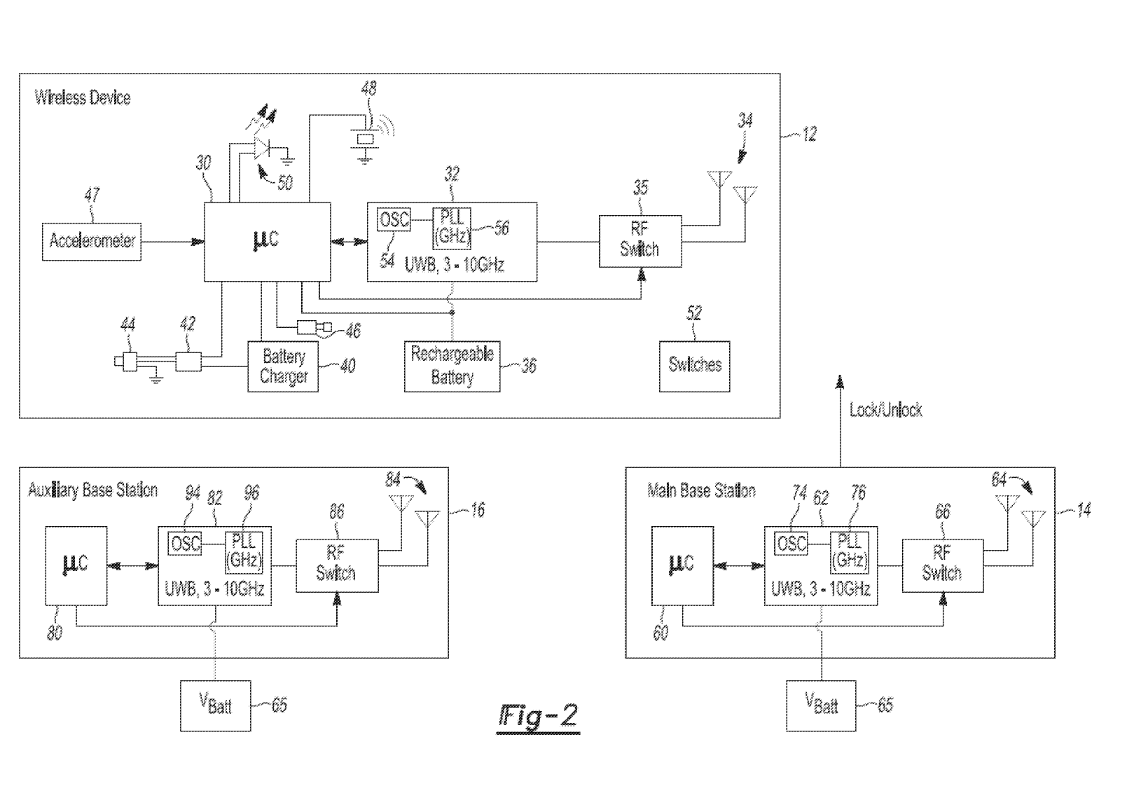

FIG. 1 depicts an apparatus 10 for detecting a location of a wireless device 12 in accordance with one embodiment. The wireless device 12 may be implemented as a key fob or other suitable device that is used to gain entry into a vehicle 18. Other suitable devices include portable electronic devices, e.g., mobile phones. The apparatus 10 includes a main base station 14 and at least two auxiliary base stations 16a-16n (“16”) for detecting the location of the wireless device 12 with respect to a vehicle 18. For example, the main base station 14 and the auxiliary base stations 16 each include a transmitter/receiver (“transceiver”) for wirelessly transmitting/receiving signals to/from the wireless device 12. While described as a transceiver, it will be understood that the circuitry for transmitting and receiving may be separate in an example. The transmitter/receiver for each of the wireless device 12, the main base station 14, and the auxiliary device 16 will be discussed in more detail in connection with FIG. 2. The auxiliary devices 16a, 16n are shown positioned at a passenger seat and at the rear of the vehicle, e.g., in the trunk. But the auxiliary devices 16a, 16n can be positioned in other locations in the vehicle, e.g., in vehicle doors, the engine compartment, side mirrors, among others.

The main base station 14 generally includes additional circuitry to lock and unlock the vehicle 18 in response to command signals as provided by the wireless device 12. The apparatus 10 may perform a passive entry passive start (PEPS) function in which the main base station 14 may unlock the vehicle 18 in response to determining that the wireless device 12 is positioned in a corresponding zone (or quadrant) 20a-20n (i.e., front driver side zone, vehicle front zone, front passenger side zone, rear passenger side zone, vehicle rear zone, and rear driver side zone, respectively) about the vehicle 18. For example, the zones 20 generally correspond to predetermined authorized locations about the vehicle 18 (e.g., interior to and exterior to the vehicle 18) such that if the wireless device 12 is detected to be in one of such zones 20, then the main base station 14 may automatically unlock the vehicle (or door) proximate to zone 20 in which the wireless device 12 is detected to be within and enable the user to start the vehicle.

The apparatus 10 may utilize remote keyless operation in addition to the PEPS function. For example, the main base station 14 may perform a desired operation (e.g., lock, unlock, lift gate release, remote start, etc.) with the vehicle 18 in the event the wireless device 12 transmits a command indicative of the desired operation while within the authorized zone 20. In addition, the apparatus 10 may be used to perform a car finder application.

In general, the main base station 14, the auxiliary base stations 16, and the wireless device 12 engage in a series of signal exchanges with one another and utilize a time of flight (TOF) implementation to determine a distance of the wireless device 12 from the vehicle 18. Thereafter, the main base station 14 may employ trilateration to locate the actual zone 20 the wireless device 12 is positioned within. At least four distance determinations are needed to determine a 3-dimensional location of the wireless device 12. The use of trilateration enables the main base station 14 the ability to locate where the wireless device 12 is located relative to the vehicle. This information (e.g., in which zone 20 the wireless device 12 is positioned) coupled with distance information as ascertained by utilizing TOF enables the main base station 14 to locate with increased levels of accuracy the location of the wireless device 12 in relation to the vehicle 18. The apparatus 10 may be arranged to precisely determine the location of the wireless device 12 about or within the vehicle 18 as opposed to conventional systems in which perhaps only the transponder may be located at various sides of the vehicle with lesser degrees of accuracy. It will be further appreciated that the wireless device 12 may provide acceleration information that can be used to further refine the location of the wireless device or predict movement of the wireless device 12 relative to zones about the vehicle.

For example, the main base station 14 may determine that the wireless device 12 is positioned at a distance of three meters away from the vehicle 18 and that the wireless device 12 is positioned in the zone 20a which corresponds to a driver side zone. The auxiliary station 16a may determine that the wireless device is four meters away in this example. While it is noted that the location of the wireless device 12 may be ascertained via the TOF and trilateration, it is recognized that the aspects noted herein with respect to locating the wireless device 12 may be applicable to other vehicle functions such as, but not limited to, tire pressure monitoring. These aspects and others will be discussed in more detail below. While utilizing the TOF, it is recognized that the main base station 14 and the auxiliary base stations 16 may be positioned at predetermined locations in the vehicle 18 for transmitting and receiving signals to and from the wireless device 12. The acceleration information of the device 12 may also be used to refine the location of the device, e.g., at the borders of the zones to resolve the location of the device.

FIG. 2 depicts a detailed schematic view of the wireless device 12, the main base station 14, and an auxiliary base station unit 16 in accordance with an embodiment. The wireless device 12 includes a microcontroller 30, a transmitter/receiver (“transceiver”) 32, and at least one antenna 34. The microcontroller 30 is operably coupled to the transceiver 32 and the antenna 34 for transmitting and receiving signals to/from the main base station 14 and the auxiliary base stations 16. Microcontroller 20 includes circuitry to process signals and output signals. A radio frequency (RF) switch 35 is operably coupled to the antennas 34 for coupling the same to the transceiver 32. A multiple antenna implementation 34 may provide for antenna diversity which may aid with respect to radio frequency multi-paths. The use of the RF switch 35 and multiple antennas are optional. For example, a single antenna 34 may be used for transmitting and receiving signal to and from the wireless device 12.

A power source 26, which can be a replaceable battery, a rechargeable battery or a capacitor, powers the microcontroller 30 and the transceiver 32. In the case of a rechargeable battery, a battery charger circuit 40 receives power from a charger connector 42 that is operably coupled to an external power supply (not shown), such as a residential electric power source. The battery charger circuit 40 may condition the incoming power from the external power supply to ensure that it is suitable for storage on the rechargeable battery 36. It is recognized that the battery charger circuit 40 and the battery 36 may wirelessly receive power from an external device for charging the same.

The battery charger 40 may indicate to the microcontroller 30 when the battery 36 is being recharged and/or the charge state of the battery 36 according to one or more embodiments. A first lighting indicator 44 may be positioned about the charger connector 42 and operably coupled to the microcontroller 30 to provide charge status of the battery 36 to a user. A vibrating motor 46 may be operably coupled to the microcontroller 30 and is arranged to provide a haptic feedback. An accelerometer 47 is operably coupled to the microcontroller 30 for detecting the motion of the wireless device 12. The accelerometer 47 is integrated into the wireless device 12 and is configured to detect 3-dimensional movement of the wireless device 12. The accelerometer can measure proper acceleration in a single-axis or a multi-axis and provide data of the detected magnitude and detected direction. The data from the accelerometer can be a vector quantity of g-force. The accelerometer 47 can be a micromachined device. For example, the wireless device 12 may be arranged to initiate the transmission of data in response to determining that it is moving, e.g., data from accelerometer 47. Such data from the accelerometer 47 can also indicate that the wireless device 12 should alter its performance, e.g., change its signaling scheme. The wire device's signaling scheme can be changed from a low energy scheme to a higher energy consumption scheme when the accelerometer 47 indicates that the device 12 has begun moving. The wire device's signaling scheme can be changed from a higher energy consumption scheme to a lower energy consumption scheme when the accelerometer 47 indicates that the device 12 has stopped moving for a period of time.

The wireless device 12 may also have a plurality of person interaction components. A piezo-sounder 48 may also be operably coupled to the microcontroller 30 and arranged to provide an audio based feedback. A second lighting indicator 50 may also be operably coupled to the microcontroller 30 and arranged to provide a visual feedback. A plurality of switches 52 are positioned on the wireless device 12, each for transmitting a command to the vehicle 18 such that a desired operation is performed (e.g., lock, unlock, lift gate release, remote start, etc.).

The transceiver 32 is generally configured to operate at an operating frequency of between 3-10 GHz. In general, by operating the transceiver 32 at this operating frequency, this condition may enable the wireless device 12, and the auxiliary base station 16 to determine a distance thereof with respect to the vehicle within a high degree of accuracy in the event the wireless device 12 engages in communication with the vehicle 18 to provide its distance from the vehicle 18. The operating frequency aspect will be discussed in more detail below. The transceiver 32 generally includes an oscillator 54 and a phase locked loop (PLL) 56 for enabling the transceiver 32 to operate at the frequency of between 3-10 GHz. By enabling the transceiver 32 to operate at an operating frequency of between 3 and 10 GHz, such a condition also enables the transceiver 32 to transmit and receive signals at an ultra-wide band (UWB) bandwidth of at least 500 MHz or at 20% of the operating frequency.

The main base station 14 generally includes a microcontroller 60, a transceiver 62, and at least one antenna 64. A radio frequency (RF) switch 66 is operably coupled to the microcontroller 60 and to the antenna 64. The RF switch 66 is operably coupled to the antennas 64 for coupling the same to the transceiver 62. A multiple antenna 64 implementation may provide for antenna diversity which may aid with respect to RF multi-paths. It is also contemplated that a single antenna 64 may be used for transmitting and receiving signal to and from the wireless device 12 without the need for the RF switch 66. The microcontroller 60 is operably coupled to the transceiver 62 and the antenna 64 for transmitting and receiving signals to/from the wireless device 12 and the auxiliary base station 16. A power source 65 in the vehicle 18 powers the microcontroller 60 and the transceiver 62. The main base station 14 further includes circuitry (not shown) for performing locking/unlocking vehicle doors and/or a liftgate/trunk and for performing remote start operation or other control signals to the vehicle.

The transceiver 62 is also generally configured to operate at the operating frequency of between 3-10 GHz. By operating the transceiver 62 at this operating frequency, this condition may enable the main base station 14 to determine the distance of the wireless device 12 with respect to the vehicle within a high degree of accuracy when it engages in communication with the wireless device 12. This will be discussed in more detail below. The transceiver 62 generally includes an oscillator 74 and a PLL 76 for enabling the transceiver 62 to operate at the frequency of between 3-10 GHz. The transceiver 62 is also configured to transmit and receive signals at the UWB bandwidth of at least 500 MHz or at about 20% of the operating frequency. By enabling the transceiver 62 to operate at the operating frequency of between 3 and 10 GHz, such a condition also enables the transceiver 62 to transmit and receive signals at the UWB range. Alternatively, in one or more embodiments, the main base station 14 does not include the transceiver 62 for communicating with the wireless device 12.

The auxiliary base station 16 generally includes a microcontroller 80, a transceiver 82, and at least one antenna 84. An RF switch 86 is operably coupled to the microcontroller 60 and to the antenna 64. The RF switch 86 and multi-antenna 84 implementation is optional for the reasons noted above. The microcontroller 80 is operably coupled to the transceiver 82 and the antenna 84 for transmitting and receiving signals to/from the wireless device 12 and main base station 14. The power source 65 in the vehicle 18 powers the microcontroller 80 and the transceiver 82.

The transceiver 82 is also generally configured to operate at the operating frequency of between 3-10 GHz. By operating the transceiver 82 at an operating frequency of between 3-10 GHz, this condition may enable the auxiliary base station 16 to determine the distance of the wireless device 12 with respect to the vehicle within a high degree of accuracy when it engages in communication with the wireless device 12. This will be discussed in more detail below. The transceiver 82 generally includes an oscillator 94 and a PLL 96 for enabling the transceiver 62 to operate at the frequency of between 3-10 GHz. The transceiver 82 is also configured to transmit and receive signals at the UWB bandwidth of at least 500 MHz or at about 20% of the operating frequency. It is recognized that the second auxiliary base station 16n is similar to the auxiliary base station 16a as described above and includes similar components and provides similar functionality.

The wireless device 12, the main base station 14, and the auxiliary base stations 16 are each arranged to transmit and receive data within the UWB bandwidth of at least 500 MHz, this aspect may place large current consumption requirements on such devices. For example, by operating in the UWB bandwidth range, such a condition yields a wide frequency spectrum and a high time resolution which improves ranging accuracy. Power consumption is less of an issue for the main base station 14 and the auxiliary base stations 16, as compared to the wireless device 12, since such base stations 14, 16 are powered from the power source 65 in the vehicle, e.g., the vehicle battery. Generally, portable devices, such as the wireless device 12, are equipped with a standalone battery. In the event the standalone battery is implemented in connection with the wireless device 12 that transmits/receives data in the UWB bandwidth range, the battery may be depleted rather quickly. To account for this condition, the wireless device 12 includes the rechargeable battery 36 and the battery charger circuit 40, along with the charger connector 42 (or wireless implementation) such that the battery 36 can be recharged as needed to support the power demands used in connection with transmitting/receiving information in the UWB bandwidth range.

In general, the larger the operating frequency of the transceivers 32, 62, and 82; the larger the bandwidth that such transceivers 32, 62, and 82 can transmit and receive information. Such a large bandwidth (i.e., in the UWB bandwidth) may improve noise immunity and improve signal propagation. This may also improve the accuracy in determining the distance of the wireless device 12 since UWB bandwidth allows a more reliable signal transmission. As noted above, an operating frequency of 3-10 GHz enables the transceivers 32, 62, and 82 to transmit and receive data in the UWB range. The utilization of the UWB bandwidth for the wireless device 12, the main base station 14, and the auxiliary base stations 16 may provide for high ranging (or positioning) accuracy and high-speed data communications. Transmission in the UWB spectrum may provide for robust wireless performance against jamming. This may also provide for an anti-relay attack countermeasure and the proper resolution to measure within, for example, a few centimeters of resolution.

The implementation of UWB in the wireless device 12, the main base station 14, and the auxiliary base station 16 is generally suitable for TOF applications.

FIG. 3 depicts a method 150 for detecting the location of the wireless device 12 in accordance with one embodiment.

In operation 152, the apparatus 10 determines the distance of the wireless device 12 using TOF measurements. TOF is known to be based on the time required for a wireless signal to travel from a first location to a second location, in which the time is generally indicative of the distance between the first location and the second location. This distance can be determined as the propagation velocity of the signal is a known parameter. This can be extended to apply to the apparatus 10. For example, the apparatus 10 may measure the time required for data (or information) to be transmitted from the wireless device 12 and to one or more of the main base station 14 and the auxiliary base station 16 and determine the distance in which the wireless device 12 is located from the vehicle 18 based on the time measurements.

To begin the process of determining the location of the wireless device 12 with respect to the vehicle 18, the wireless device 12 may transmit a polling signal if it proximate to the vehicle 18, for the vehicle 18 to determine the location of the wireless device 12. In this case, the wireless device 12 may periodically transmit the polling signal in response to detecting a motion thereof. The accelerometer 47 within the wireless device 12 may transmit a motion signal to the microcontroller 30 that indicates that the wireless device 12 is in motion. The polling signal may include information based on the sensed acceleration by accelerometer 47. Any one of the main base station 14 and the auxiliary base stations 16 may receive the polling signal and respond back to the wireless device 12. For example, assuming, the main base station 14 receives the polling signal, the main base station 14 may then transmit a first signal and include a first time stamp therein. The first signal is transmitted to the wireless device 12. The wireless device 12 receives the first signal with the first time stamp and generates a second signal including a second time stamp corresponding to the time it received the first signal. The wireless device 12 transmits the second signal back to the main base station 14. The main base station 14 may then determine a round trip time based on the first time stamp and on the second time stamp. The round trip time may correspond to the time measurement which is indicative of the distance between wireless device 12 and the main base station 14. This exchange may be repeated any number of times such that any number of time measurements may be ascertained. Multiple measurements may improve the accuracy of the distance determination. In one or more embodiments, the main base station 14 does not include an internal transceiver 32 and does not determine a distance between itself and the wireless device 12.

After exchanging signals between the wireless device 12 and the main base station 14 to determine the first distance D1, the wireless device 12 and the auxiliary base station 16a may engage in a similar exchange (e.g., insertion of time stamps) such that the second distance D2 is obtained which corresponds to the distance between the wireless device 12 and the auxiliary base station 16a. Again, multiple signal exchanges with multiple time stamps may be used to improve the accuracy of the distance determination. In an example, the exchanging of signals between the wireless device 12 and the auxiliary base station 16a may occur simultaneously or overlapping with the exchange of signals with the main base station 14.

After exchanging signals between the wireless device 12 and the auxiliary base station 16a to determine the second distance D2, the wireless device 12 and the auxiliary base station 16n may engage in a similar exchange (e.g., insertion of time stamps) such that the third distance D3 is obtained which corresponds to the distance between the wireless device 12 and the auxiliary base station 16n. Multiple signal exchanges with multiple time stamps may be used to improve the accuracy of the distance determination.

It is to be noted that the above signal exchange between the wireless device 12, the main base station 14, and auxiliary base stations 16 may take into account delay times generally associated with electronics in the wireless device 12 and in the base stations 14, 16 for providing the time measurements.

Once the auxiliary base stations 16a and 16n determine the second distance D2 and the third distance D3, each of the auxiliary base stations 16a and 16n may wirelessly transmit such data to the main base station 14. The main base station 14 uses the distances D1, D2, and D3 to determine in which zone 20 the wireless device 12 is positioned. This will be discussed in more detail below. The utilization of the operating frequency at between 3-10 GHz and the transmission/reception of information within the UWB bandwidth generally enables the wireless device 12, the main base station 14, and the auxiliary base stations 16 to process the time measurement with a high degree of resolution so that the main base station 14 and the auxiliary base stations 16 each provide a corresponding distance (e.g., D1, D2, and D3) within a high degree of resolution. An example of a high degree of resolution is in the range of one centimeter to three centimeters.

Alternate embodiments contemplate that the wireless device 12 itself may provide a distance reading in a similar manner to that stated above while engaging in TOF measurements with the main base station 14 and/or the auxiliary base stations 16 while also operating at the operating frequency corresponding to the distance accuracy value D_{ACC}_{_{—}}_{VAL}. In this case, the wireless device 12 may provide a distance reading to the main base station 14. The main base station 14 may then use the distance reading from the wireless device 12 and those from the auxiliary base station(s) 16 to determine the location of the wireless device 12. The wireless device 12 can also use the acceleration information from accelerometer 47 to determine location/position of the device 12 relative to the vehicle.

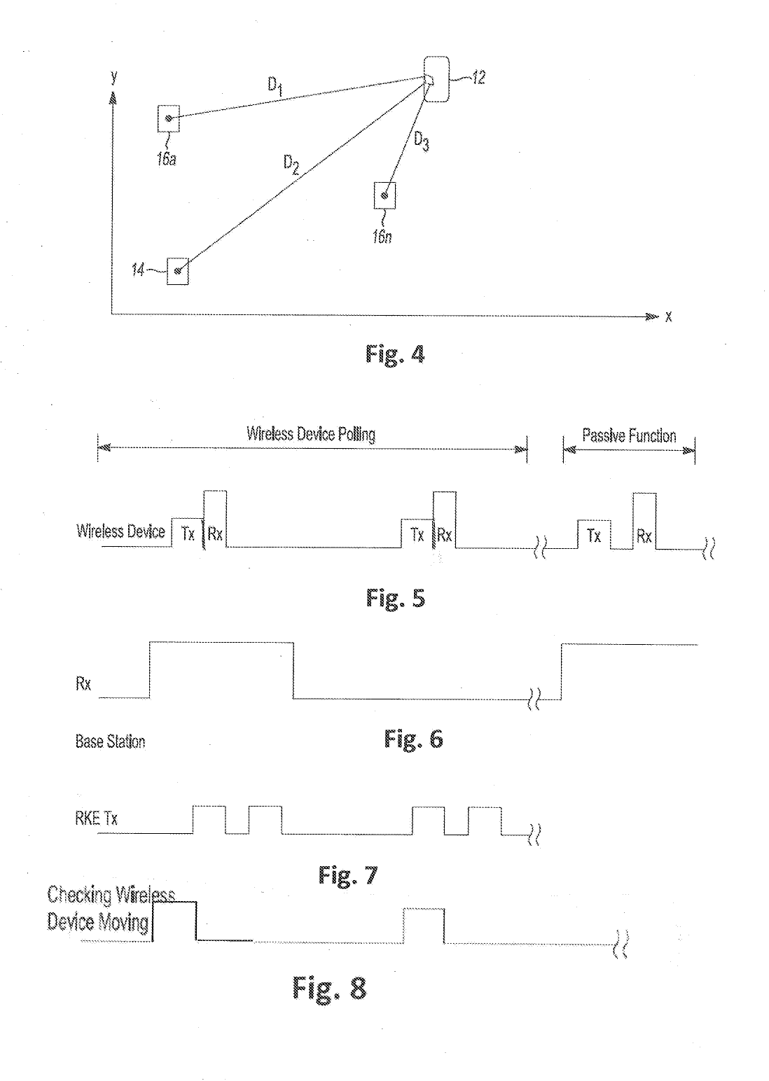

FIG. 4 generally illustrates the distances (e.g., D1, D2, and D3) as determined by the main base station 14, the auxiliary base station 16a, and the auxiliary base station 16n. It is recognized that at least three reference points (or three distance measurements (e.g., D1, D2, and D3)) may be needed for the main base station 14 to ascertain which zone 20a-20n the wireless device is located in when the main base station 14 performs trilateration. In an example, the acceleration information at the wireless device 12 can also be used to determine location/position of the device 12.

In operation 154, the main base station 14 employs trilateration to determine the zone 20a-20n in which the wireless device 12 is positioned. As noted above, the apparatus 10 may use the TOF implementation to ascertain the distance (e.g., D1, D2, D3) of the wireless device 12 from the vehicle 18. However, the zone 20 in which the wireless device 12 is positioned in may not be known even if the distances (e.g., D1, D2, D3) are known.

Generally, trilateration employs determining an absolute or relative location of points via measurement of distance by examining the geometry of circles, spheres, or triangles. An example of trilateration is set forth in “Intersection of two circles,” Paul Bourke, April 1997 and in “Trilateration,” Alan Kaminsky, Mar. 8, 2007, which are hereby incorporated by reference. If the disclosure incorporated by reference conflicts with the present explicit disclosure, the explicit disclosure controls interpretation. In an example, the main base station 14 may use the three distances D1, D2, and D3 and utilize trilateration to find coordinates (e.g., zone) whereat the wireless device 12 is positioned. The coordinates of the wireless device 12 may correspond to a point in the x, y, z axis. Once the final coordinates are ascertained, the main base station 14 may perform a predetermined operation based on the final coordinates of the wireless device 12. For example, the main base station 14 may unlock a door or liftgate. In another example, the main base station 14 may send a message over a communication bus to enable a remote start operation. Such a remote start operation may further begin environmental controls as desired by a specific user associated with the electronic device 12. Any number of vehicle operations may be performed once the final coordinates are ascertained.

One such vehicle operation can be determining the zone in which the wireless device is located and opening a door or trunk when the accelerometer 47 indicates that the wireless device has stopped in the zone corresponding to the door or trunk. For example, the distances indicate that the wireless device 12 is in zone 20e at the rear of the vehicle; the distances can be short to station 16n and longer and about equal to stations 14 and 16a. In one case the wireless device 12 via its accelerometer 47 indicates that the device is moving around the vehicle toward the zone 20f. Here there is no vehicle operation. In another case, the accelerometer 47 stops at the center of the trunk. Here, the vehicle operation can be opening the trunk. In the example, shown in FIG. 1, the wireless device 12 is adjacent the driver-side door in zone 20a. If the accelerometer 47 indicates that the wireless device 12 is stopped adjacent the door, then the vehicle operation can be unlock, and optionally open, the door. If the accelerometer indicates the wireless device 12 continues to move in or through zone 20a toward or to zone 20f, then there is no vehicle operation. As explained in these examples, the acceleration data from the wireless device 12 can be the trigger for certain vehicle operation(s).

Alternate embodiments contemplate that the wireless device 12 may also perform trilateration instead of the main base station 14. For example, as noted above, the wireless device 12 may use the distance reading that it has calculated in addition to the distance readings (e.g., D1, D2, and/or D3) from the main base station 14, the auxiliary base station 16a, and/or the auxiliary base station 16n and perform the trilateration with these readings to determine the zone 20 in which the wireless device 12 is positioned. This information can be sent to the main base station 14.

FIG. 5 depicts the manner in which the wireless device 12 polls for a signal from one or more of the main base station 14 and the auxiliary base stations 16 in accordance to an embodiment. The polling operation 600 of the wireless device 12 occurs automatically and without user intervention (e.g., without the user pressing a button on the wireless device 12 or the like). The wireless device 12 transmits data packets (at Tx) at a predetermined period (Tpoll). In one embodiment, period, Tpoll, is equal to approximately 1.0 s. The Y-axis indicates power consumption for the respective function. The wireless device 12 listens (at Rx) for a signal back from the stations 14, 16. Once the wireless device 12 receives the required signals back from stations 14, 16, the wireless device 12 enters passive function operation where communications are different than the polling operational mode. The receive (Rx) mode of the wireless device consumes more power than the transmit mode (Tx). In an example, the wireless device 12 does not start the polling until the accelerometer indicates that the device 12 is moving. That is the polling function is off until the device 12 is in motion.

FIG. 6 depicts the manner in which the main base station 14 and/or the auxiliary base stations 16 poll for a signal from the wireless device 12 in accordance to one embodiment. The stations 14, 16 are initially “off.” Off is indicated as low on the Y-axis. On is indicated as high on the Y-axis. The station 14, 16 transitions for a time period. If no signal from wireless device 12 is detected during the on time period, then the station turns off. This process repeats until the station 14, 16 detects a polling signal from the wireless device 12. While not shown in FIG. 6, the station 14, 16 will transmit an acknowledgement signal to the wireless device 12 when it detects a transmitted polling signal from the wireless device 12. Such an acknowledgement signal may be received by the wireless device 12 when it is in the receive mode. However, if the wireless device 12 is not in a receive mode, it will not receive the acknowledgement signal. Once wireless device 12 receives the acknowledgement signal, the wireless device 12 leaves polling mode and moves to passive function mode.

FIG. 7 depicts the manner in which the wireless device 12 is actuated by a user and the relationship to timing of the main base station 14 and/or the base stations 16 in the vehicle 18 in accordance to one embodiment. Here wireless device 12 enters a remote keyless entry (RKE) mode for initiating the polling operation. Upon the operator activating the wireless device 12 (such as by pressing a button or switch, gesturing, accelerating, or moving), it transmits a polling signal and then is configured for a period of time to receive a polling signal from the station 14, 16. This process repeats each time the operator activates the wireless device. In an example, the accelerometer data is also used to trigger the polling operation.

FIG. 8 depicts the wireless device 12 polling internally to check for movement in accordance with an embodiment. As noted above, the wireless device 12 includes the accelerometer 47, which is configured to detect any 3-dimensional movement of the wireless device 12. The accelerometer 47 reports any such movement to the microcontroller 30. The movement can be a change in acceleration. The accelerometer 47 can also report a reading to the microcontroller 30, which then determines a change in acceleration. In turn, the microcontroller 30 may enable certain functionality of the wireless device 12 while movement is detected. For example, in an embodiment, such movement serves as a trigger mechanism for the wireless device 12 to initiate transmission of the polling signal as noted above in connection with FIG. 4 such that TOF measurements can be performed thereafter by the main base station 14 and the auxiliary base station 16. That is, the movement is detected by the accelerometer 47 before the wireless device 12 begins a transmission or a reception function. Conversely, the microcontroller 30 is configured to disable certain functionality of the wireless device 12 (e.g., polling), when no movement is detected. For example, if no movement is detected for a period of time, the controller 30 turns off or goes into a low power mode. The accelerometer 47 can wake the controller 30 from its low power mode when it detects a movement of the device 12.

In a use case where the accelerometer wakes the controller based on detected movement, the controller 30 may only wake to a receive mode. In this receive mode the controller 30 listens for a low power, low frequency signal from the vehicle. A low frequency signal can be less than 500 MHz, less than 200 MHz, or about 125 MHz or less. In use, the controller 30 can, when woken by the accelerometer 47, now validate certain functions in the vehicle, e.g., keyless entry, keyless ignition, keyless truck access, locking, emergency warning, environmental controls, and the like.

As indicated above, the wireless device 12 initiates polling by transmitting a signal (Tx), (shown in FIG. 6), and then enters a reception mode (Rx) for receiving an acknowledgement signal from the vehicle. The frequency range used for both transmission/reception is RF (e.g., 3-7 GHz or 3-10 GHz) with ultra wide band (UWB). Due to the relatively high frequency used and operation in the UWB, there is relatively more current consumption used by the wireless device 12 to conduct the polling, as compared to existing low frequency methods.

The wireless device 12 is configured to turn off when it is not polling, to conserve battery energy. The accelerometer 47 is integrated into the wireless device 12 and is configured to detect 3-dimensional movement of the wireless device 12. Other embodiments of the wireless device 12 contemplate other types of sensors for measuring movement, such as a gyroscope (not shown). In general, while movement is detected, the wireless device 12 is enabled to initiate the polling sequence (i.e., the wireless device 12 is ON). While movement is absent, the wireless device 12 is disabled from initiating the polling sequence (i.e., the wireless device 12 is OFF). The purpose of this general scheme is to save energy (i.e., reduce current consumption). Saving energy can extend battery life in the wireless device 12. This can be understood in that when the wireless device 12 is sitting on a desk during the day, on the kitchen counter at night, in the purse/pocket of a person sitting at a desk during the day, etc., then the wireless device 12 does not poll, because the vehicle (and wireless device 12) is not being used by the user.

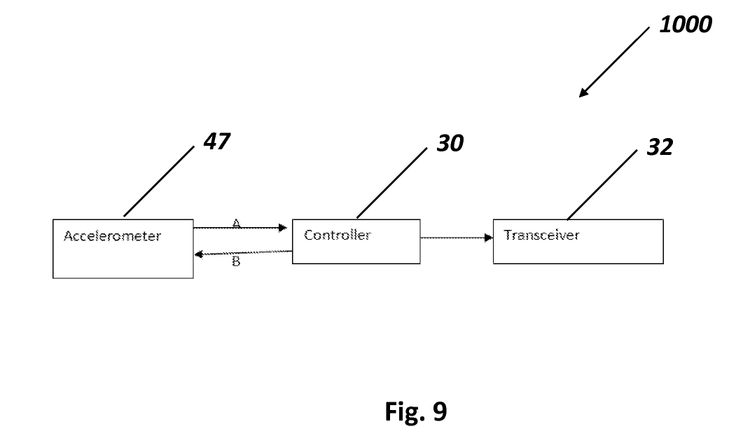

With reference to FIG. 9, a method for initiating polling is illustrated in accordance with one or more embodiments and is generally represented by numeral 1000. In an embodiment, the accelerometer 47 wakes up the microcontroller 30 when the accelerometer 47 detects movement, as depicted by signal “A”. In another embodiment, the microcontroller 30 of the wireless device 12 periodically polls, or wakes up the accelerometer 47 for movement, as depicted by signal “B”. In either method, A or B, once movement of the wireless device 12 is detected, the wireless device 12 transmits a polling signal. In other embodiments, the polling signal is transmitted after a few affirmative movement confirmations in the wireless device 12.

In one or more embodiments, the wireless device 12 is configured to operate in a polling mode that is dependent upon the location of the wireless device 12 relative to the vehicle. As stated above, the vehicle (e.g., the main base station 14 and auxiliary base stations 16) determines the location of the wireless device 12. In one embodiment, the base stations 14, 16 select a polling mode based on the present location of the wireless device 12, and instruct the wireless device 12 to operate in the selected polling mode. For example, in an embodiment, if the wireless device 12 is presently located within the vehicle, then the base stations 14, 16 instruct the wireless device 12 to continue polling even if no movement is detected.

In general, the wireless device 12 may be controlled to be placed in a special mode: 1) listen only mode (may be periodic); 2) slower/faster polling mode; and 3) periodic transmission only mode. Such modes may be selected based on the present location of the wireless device 12 relative to the vehicle.

As such, existing polling methods typically maintain the receiver of the wireless device in an ON state during polling. Such methods discharge the battery of the wireless device quickly, especially when the devices are communicating within the UWB bandwidth. The presently disclosed polling method repeatedly turns off the wireless device during polling to extend the charge of the battery of the wireless device.

The wireless communication between the device 12 and the base stations 14, 16 can be within a wide band or ultrawide band of radio frequency communication. These can include pulsed communications with an emitted signal that exceeds 500 MHz or 20% of the center frequency.

The above described example use time-of-flight measurements to determine the location of the wireless device 12 relative to the vehicle using base stations 14, 16. However, in alternative embodiments, the location of the wireless device 12 can be determined using received signal strength indication (RSSI) measurements. That is, the strength of a signal received at each base stations 14, 16 along with the accelerometer data from the device 12 can be used to locate the device 12 relative to the vehicle. It may be required to transmit multiple signals from the device 12 at varying power levels to have sufficient data to locate the device 12 using trilateration. It is understood that trilateration does not require the calculation of angles to determine the position/location of the wireless device 12.

The wireless device as described herein can be a portable electronic device that can be carried by a person, e.g., a driver of a vehicle such as an automobile, motorcycle, truck, tractor or the like. The wireless device can be a fob that encloses circuitry, e.g., a microprocessor, control circuits, memory, accelerometer circuits, transmitter circuits, receiver circuits, micro-machines electro-mechanical device(s) and the like, in a housing. The housing can shield and protect the internal circuitry. The fob can be a key fob that acts as a key or can be attached to a key. The fob can include any of the wireless device structures described herein and perform the functions of the wireless device described herein. The portable electronic device can also be a mobile communication device, e.g., a smart phone, which includes any of the wireless device structures described herein and perform the functions of the wireless device described herein.

In an example, a wireless device system for a vehicle includes a vehicle communication system and a wireless device including an accelerometer to detect movement of the device and to generate an accelerometer signal reflective of said movement. The vehicle communication system comprises a base station affixed to the vehicle and configured to send and receive signals and vehicle circuitry connected to the base station and configured to trigger a vehicle operation. Vehicle operations can include unlocking doors, starting vehicle, operating entertainment system, operating environmental controls and the like. The vehicle operation can be based at least in part on a position or motion of the wireless device determined in whole or in part based on the accelerometer signal. In an example, the vehicle circuitry uses time-of-flight to determine the position of wireless device using signals received by the base station and the auxiliary station. In an example, the vehicle circuitry uses a low frequency signal to determine that the wireless device is in a position by the vehicle. In an example, the controller in the wireless device periodically checks the accelerometer for data representing movement of the wireless device. In an example, the transceiver of the wireless device is configured to transmit an ultra-wide band polling signal, and at a frequency of greater than 3.0 GHz. In an example, the accelerometer only detects movement when instructed by the controller. In an example, the controller determines movement when it receives more than two movement indications from the accelerometer. In an example, the controller determines position of the wireless device relative to the vehicle after receiving signals from the vehicle. In an example, the base station is positioned at driver side of the vehicle and an auxiliary base station includes at least one auxiliary unit spaced from the main base station, and wherein the location of the wireless device is determined using at least two signals from the base station and the at least one auxiliary unit.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

I claim:

1. A wireless device for communicating with a vehicle comprising:
an accelerometer to detect movement of the device;
a controller operatively connected to the accelerometer to receive a signal from the accelerometer, wherein the controller is configured to produce a polling signal or turn on a signal reception mode when the accelerometer has detected movement; and
a transceiver connected to the controller and configured to transmit a polling signal from the device or to receive a vehicle signal at the device.

2. The wireless device of claim 1, wherein the controller periodically checks the accelerometer for data representing movement.

3. The wireless device of claim 2, wherein the transceiver is configured to transmit an ultra-wide band polling signal.

4. The wireless device of claim 3, wherein the transceiver is configured to transmit the polling signal at a frequency of greater than 3.0 GHz.

5. The wireless device of claim 1, wherein the accelerometer only detects movement when instructed by the controller.

6. The wireless device of claim 1, wherein the controller determines movement when it receives more than two movement indications from the accelerometer.

7. The wireless device of claim 1, wherein the controller includes a first mode that listens for a signal from the vehicle before sending a polling signal; a second mode that uses the accelerometer detected movement to trigger the polling signal; and a third mode that periodically transmits the polling signal.

8. The wireless device of claim 1, wherein the controller determines position of the wireless device relative to the vehicle after receiving signals from the vehicle.

9. The wireless device of claim 1, further comprising a key fob housing containing the accelerometer, the controller and the transceiver.

10. The wireless device of claim 1, wherein the controller has a low power mode and wherein the accelerometer wakes the controller from the low power mode when it detects movement.

11. A wireless device system for a vehicle comprising:
a vehicle communication system including:
a main base station configured to send and receive signals;
at least one auxiliary base station configured to send and receive signals; and
vehicle circuitry connected to the main base station and the auxiliary base station and configured to trigger a vehicle operation; and
a wireless device including:
an accelerometer to detect movement of the device;
a controller operatively connected to the accelerometer to receive a signal from the accelerometer, wherein the controller is configured to produce a polling signal with the accelerometer has detected movement; and
a transceiver connected to the controller and configured to transmit a polling signal from the device or to receive a signal from the vehicle communication system;
wherein at least one of the vehicle circuitry and the controller determining a position of the wireless device relative to the vehicle, wherein the vehicle operation is based at least in part on the vehicle position.

12. The system of claim 11, wherein vehicle circuitry uses time-of-flight to determine the position of wireless device using signals received by the base station and the auxiliary station.

13. The system of claim 11, wherein the vehicle circuitry uses a low frequency signal to determine that the wireless device is in a position by the vehicle.

14. The system of claim 11, wherein the controller periodically checks the accelerometer for data representing movement of the wireless device.

15. The system of claim 11, wherein the transceiver is configured to transmit an ultra-wide band polling signal, and at a frequency of greater than 3.0 GHz.

16. The system of claim 11, wherein the accelerometer only detects movement when instructed by the controller.

17. The system of claim 11, wherein the controller determines movement when it receives more than two movement indications from the accelerometer.

18. The system of claim 11, wherein the controller determines position of the wireless device relative to the vehicle after receiving signals from the vehicle.

19. The system of claim 11, wherein the main base station is positioned at driver side of the vehicle, wherein the auxiliary base station includes at least one auxiliary unit spaced from the main base station, and wherein the location of the wireless device is determined using at least two signals from the base station and the at least one auxiliary unit.

20. A wireless device system for a vehicle comprising:
a vehicle communication system including:
a base station affixed to the vehicle and configured to send and receive signals; and
vehicle circuitry connected to the base station and configured to trigger a vehicle operation; and
a wireless device including an accelerometer to detect movement of the device and to generate an accelerometer signal reflective of said movement;
wherein the vehicle operation is based at least in part on a position or motion of the wireless device determined in whole or in part based on the accelerometer signal.
